(19) United States
(12) Patent Application Publication
(10) Pub. No.: US 2017/0295544 A1
(43) Pub. Date: Oct. 12, 2017

(54) Methods for waking up wireless devices

(71) Applicant: Jichun Li, Miluo (CN)

(72) Inventor: Jichun Li, Miluo (CN)

(21) Appl. No.: 15/484,347

(22) Filed: Apr. 11, 2017

(30) Foreign Application Priority Data
Apr. 11, 2016 (CN) 201610221413.1

(51) Int. Cl. H04W 52/02

(52) U.S. Cl. CPC H04W 52/0222; H04W 52/0229

(57) ABSTRACT

A method for waking up wireless device includes the following concrete steps: the master device in the wireless devices contains RF transceiver module, when the RF transceiver module works at operating frequency, they are used for receiving and sending data frame; The wireless device also contains the waking-up device used for continuously sending waking data packet to wake up a slave device; the RF transceiver module of the slave device in the wireless device converts frequency to wake frequency, then go dormant, when it wakes, if it receives waking data packet, it converts to operating frequency and broadcasts the news that the slave device is already awake, when the master device receives the news, it sends data frame to the slave device; the slave device receives the data frame from the master device and executes instruction.

### FIELD OF THE INVENTION

The present invention relates to wireless communication technology field, particularly to methods for waking up wireless devices.

### BACKGROUND OF THE INVENTION

In the wireless devices powered by battery, in order to prolong life they usually need access sleep mode when the devices are standby. When the devices are needed to process information or executive action, the devices are wakened up from sleep mode to activity mode.

The principle for waking up the wireless devices is as follow: the wireless devices are automatically awake in period, in the very short time of waking up, if the devices don't find calling signal, they will sleep immediately; if the devices find calling signal, the devices are awake up and access activity model.

For example, referring to FIG. 1

Step 1 The wireless devices wake up once each second with internal timer, then enter signal receiving state and keep for some time (for example 1 ms).

Step 2 If the devices receive the wireless signal in a waking-up period, they will obtain the data and determine whether to wake up themselves or not. If they determine to wake up themselves, they will send the successful message of waking up and enter wireless receiving state, receive and deal with information. If they determine not to wake up themselves, they will enter sleep state again.

In the example, a master device needs one second to wake up a slave device, in other words, the response time is one second. And in the one second the master device can't receive and deal with other wireless signal.

### SUMMARY OF THE INVENTION

To overcoming the shortcomings in the prior art, the object of the present invention is to provide methods for waking up wireless devices with the advantages of reducing response time, accelerating reaction speed, reducing standby energy consumption, improving reliability of wireless network communication.

The technologies in the present invention are as follows:

A method for waking up wireless devices includes the following concrete steps: a master device in a wireless devices contains RF transceiver module, when the RF transceiver module works at operating frequency, it is used for receiving and sending data frame; the wireless device also contains a waking-up device used for continuously sending waking-up data packet to wake up a slave device; the RF transceiver module of the slave device in the wireless device converts to wake frequency, then goes dormant, when it wakes, if it receives the waking-up data packet, it converts to operating frequency and broadcasts the news that the slave device has already be wakened, when the master device receives the news, it sends data frame to the slave device; the slave device receives the data frame from the master device and executes instruction.

As an further technical scheme in the present invention, the waking-up device is used as a separate equipment, or as a RF waking up module in the master device.

As an further technical scheme in the present invention, when the waking-up device is used as a separate equipment, the operating process of the master device is as follows:

step 1 when it needs to wake up a device, the waking-up device receives the waking-up instruction from the master device and continuously sends the waking-up data packet to the slave device in a waking-up period;

step 2 the RF transceiver module in the master device enters receiving state and waits for answer-back signal;

step 3 the RF transceiver module receives the answer-back signal from the slave device;

step 4 the RF transceiver module sends control instruction, then enters receiving signal state and waits for the salve device to feedback signal;

step 5 the RF transceiver module receives the feedback signal, then ends interactive control once.

As an further technical scheme in the present invention, when the waking-up devices is used as a RF waking-up module in the master device, the operating process of the master device is as follows:

step 1 when it needs to wake up a slave device, the RF waking-up module in the master device uses the waking-up frequency to continuously send the waking-up data packet in a waking-up period;

step 2 the RF transceiver module in the master device enters receiving state and waits for answer-back signal;

step 3 the RF transceiver module receives the answer-back signal from the slave device;

step 4 the RF transceiver module sends control instruction, then enters receiving signal state and waits for feedback signal from the salve device;

step 5 the RF transceiver module receives the feedback signal, then one control interaction is end.

As an further technical scheme in the present invention, the operating process of the slave device is as follows:

step 1 the RF transceiver module in the slave device switches to wake frequency, then it enters sleep mode; after it automatically wakes with internal timer, it waits for receiving the waking-up data packet; if it does not receive the waking-up data packet, after the waking-up period is end, it will enter sleep state again;

step 2 if it receives data packet, it will judge whether to wake up the slave device or not; if it determines not to wake up the slave device, it will enter sleep state again after the waking-up period; if it determines to wake up the slave device, it will enter step 3;

step 3 the RF transceiver module switches to the operating frequency;

step 4 it broadcasts the news that the slave device has been waken up;

step 5 after the master device receives the news, it will send data frame to the slave device; the slave device receives the data frame from the master device and executes instruction;

step 6 after the communication and service between the slave device and the master device are finished, the RF transceiver module switches to the wake frequency, and enters sleep state again.

Compared with the prior art, the advantages of the present invention are as follows:

The present invention provides a method for waking up wireless devices, that is the operating frequency and the waking frequency are not the same frequency. The slave device and the master device can communicate before the waking-up bursts of packets ends. It reduces response time, accelerates reaction speed, reduces standby energy consumption and improves reliability of wireless network communication.

### BRIEF DESCRIPTION OF THE DRAWINGS

FIG. 1 is the wake-up principle view of the wireless device in the prior art.

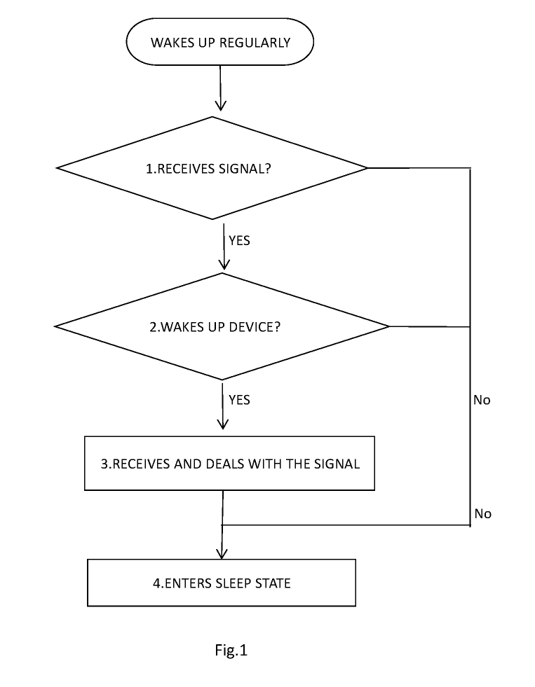

FIG. 2 is the operating principle view of the master device in the present invention.

FIG. 3 is the operating principle view of the slave device in the present invention.

### DETAILED DESCRIPTION OF ILLUSTRATED EMBODIMENTS

The follows will clearly and completely describe the technical scheme with the implementation examples in the present invention, obviously, the described examples are just a part of them, not all of them. Based on the examples in the present invention, all other example gained by the general technical personnel in this field without creative work belong to the prospective scope of the present invention.

### EXAMPLE 1

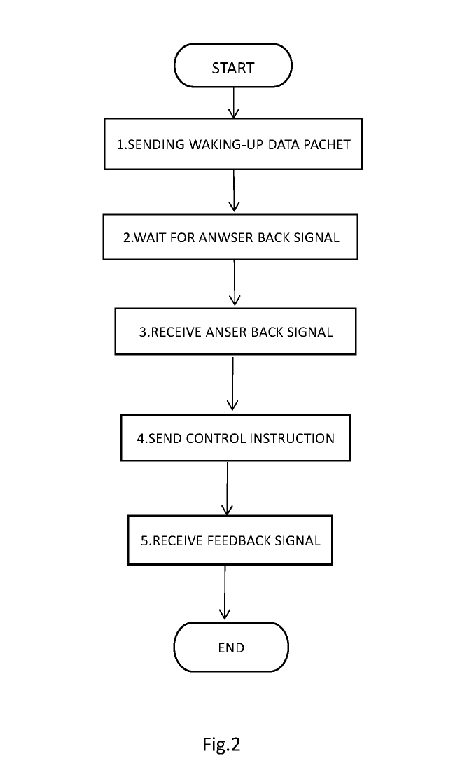

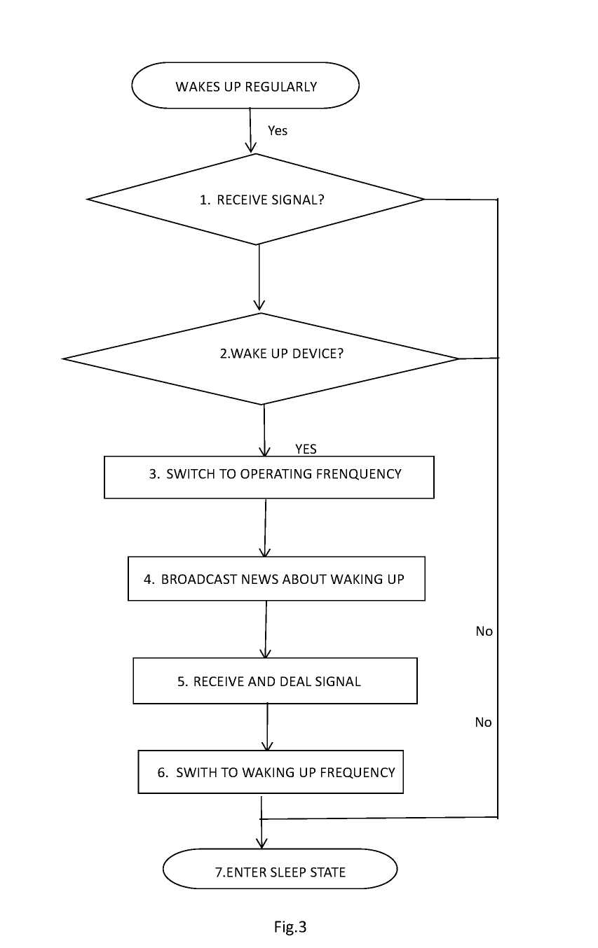

Referring to FIGS. 2 and 3, in the example of the present invention, a method for waking up wireless device, the master device of the wireless device has two FR transmitter modules, respectively used FR transceiver module and RF waking-up module, the FR transceiver module works at work frequency, used for receiving and sending data frame; the RF waking-up module works at waking-up frequency, used for waking-up bursts of packets. The working process of the master device is described as follows:

step 1 when it needs to wake up some slave device, the RF wake-up module in the master device uses the waking up frequency to continuously send the waking up data packet in a waking up period (for example 10000 ms);

step 2 the RF transceiver module in the master device enters receiving state, and wait for answer-back signal;(notice, because the RF waking-up module and the FR transceiver module are not the same, they can work at the same time.)

step 3 the RF transceiver module receives the answer-back signal from the slave device;

step 4 the RF transceiver module sends control instruction, then enters receiving signal state and waits for feedback signal from the slave device;

step 5 the RF transceiver module receives the feedback signal, then one control interaction is end.

The RF transceiver module of the slave device in the wireless device switches to the wake frequency, then enters sleep state, when it wakes, if it receives the waking-up data packet, it will switch to the operating frequency and broadcast the news that the slave device has wakened. The operating process of the slave device is concretely described as follows, referring FIG. 3:

step 1 the RF transceiver module in the slave device switches to wake frequency, then it enters sleep mode; after it automatically recovers with internal timer, it waits for receiving waking up data packet; if it does not receive data packet, after the wake period is end, it will enter sleep state;

step 2 if it receives the data packet, it will judge whether to wake up the slave device or not; if it determines not to wake up the slave device, it will enter sleep state again after the wake period; if it determines to wake up the slave device, it will enter step 3);

step 3 the RF transceiver module switches to operating frequency;

step 4 it will broadcast the news that the slave device has wakened;

step 5 after the master device receives the news, it will send data frame to the slave device; the slave device receives the data frame from the master device and executes instruction;

step 6 after the communication and service between the slave device and the master device are finished, the RF transceiver module switches to wake frequency, and enters sleep state again.

In the above process, the slave device can communicate with the master device without waiting for one second for the end of the waking-up period.

Benefit Analysis:

suppose the wireless receiver sleeps for 999 milliseconds and then wakes for 1 millisecond, that takes 1000 milliseconds for a cycle.

Take low power RF chip CC430 as an example: in signal receiving state the current is 18.5 mA, in sleep state the current is 2 μA.

The length of the wake data frame is 4 bytes (that is 32 bits), the wireless baud rate is 100 Kbps.

The Response Time

The transceiver time of the waking-up data packet is 4 bytes, equaling to 32 bits, 32 bits adds start bit and sync bit to totally 50 bits/250K, equaling to 0.2 millisecond, that is, it can send a data packet in 0.2 millisecond, in a wake cycle (1 millisecond) it can send five data packets; if the device receives waking-up message when it wakes up, the response time is equal to 0.2 millisecond, if the device receives the waking-up message at the last moment in a waking period, then the response time is equal approximately to 1000 milliseconds. So the average waking-up time is 0.5 second.

On constant frequency, the waking-up time is 1 second.

So the response time in the present invention is reduced 50%.

The Standby Energy Consumption

The sleep energy consumption in each year=the sleep time *sleep current=(999/1000)*24*365*0.002=17.5 (mah)

The waking-up energy consumption in each year=the waking-up time *receiving current=(1/1000)*24*365*18.5=162.06 (mah)

The waking-up waiting energy in each year is zero. Because when the device is wakened, it will communicate with the master device at once.

The operating energy consumption in each year=work time*work current=0.1/3600*24*365*18.5=4.5 (mah)

The energy consumption in each year=the sleep energy consumption in each year+the waking-up energy consumption in each year+the waking-up waiting energy consumption in each year+the operating energy consumption in each year=8.75+162.06+0+4.5=175.31 (mah)

Under the condition of constant frequency, the wake-up waiting energy in each year=the wait time*the work current=(0.5/3600)*24*365*18.5=22.5

So the technical schemes in the present invention reduce 12.8% energy consumption.

Communication Quality

In the present invention, it adopts different frequency to send waking-up signal that promises no effect on the normal communication frequency and improve the reliability of wireless network communication.

The terminologies used in the present invention are as follows:

The wireless waking-up: From the perspective of phenomenon, it seems that the transmitter wakes up the receiver from sleep state. In fact, the receiver automatically wakes up in period with the internal timer, in the very short timer of waking, if it finds calling signal, it will wake up and enter receiving state.

The operating frequency: the wireless device adopts wireless frequency after it normally receives and sends signal. The present invention takes 433 MHz as example, but it is not limited this.

The waking-up frequency: the waking-up signal frequency sending from the wireless transmitter and the wireless signal frequency received by the slave device when it briefly wakes up. The present invention takes 430 MHz as example, but it is not limited this.

The master device: it is used for contacting the slave device and sending control command in a wireless communication device.

The slave device: the device is chosen by the master device and execute the task.

The response time: the time that the master device sends wake up data packet to receive the response data packet from the slave device. The shorter is the response time, the faster is the reaction rate of the device, the lower is the standby energy consumption of the device.

To the technical persons in this field, it is obviously that the present invention is not limited the details disclosed in the examples, Under the situation of not betraying the spirit or the basic feature in the present invention, the present invention can be achieved by the other concrete form. So, no matter from which point of view, the examples should be taken as exemplary, and not restriction the prospective range.

I claim:

1. Method for waking up wireless device includes following concrete steps: a master device in a wireless devices contains RF transceiver module, when said RF transceiver module works at operating frequency, it is used for receiving and sending data frame; said wireless device also contains a waking-up device used for continuously sending waking-up data packet to wake up a slave device; said RF transceiver module of said slave device in said wireless device converts to wake frequency, then goes dormant, when it wakes, if it receives said waking-up data packet, it converts to operating frequency and broadcasts a news that said slave device has already be wakened, when said master device receives said news, it sends data frame to said slave device; said slave device receives said data frame from said master device and executes instruction.

2. The method for waking up wireless device according to claim 1, wherein said waking-up device is used as a separate equipment, or as a RF waking up module in said master device.

3. The method for waking up wireless device according to claim 2, wherein when said waking-up device is used as said separate equipment, the operating process of said master device is as follows:
step 1 when it needs to wake up a device, said waking-up device receives a waking-up instruction from said master device and continuously sends said waking-up data packet to said slave device in a waking-up period;
step 2 said RF transceiver module in said master device enters receiving state and waits for answer-back signal;
Step 3 said RF transceiver module receives said answer-back signal from said slave device;
step 4 said RF transceiver module sends control instruction, then enters receiving signal state and waits for said salve device to feedback signal;
step 5 said RF transceiver module receives said feedback signal, then ends interactive control once.

4. The method for waking up wireless device according to claim 2, wherein when said waking-up device is used as a RF waking-up module in said master device, the operating process of said master device is as follows:
step 1 when it needs to wake up some slave device, said RF waking-up module in said master device uses said waking-up frequency to continuously send said waking-up data packet in a waking-up period;
step 2 said RF transceiver module in said master device enters receiving state and waits for answer-back signal;
step 3 said RF transceiver module receives said answer-back signal from said slave device;
step 4 said RF transceiver module sends control instruction, then enters receiving signal state and waits for feedback signal from said slave device;
step 5 said RF transceiver module receives said feedback signal, then one control interaction is end.

5. The method for waking up wireless device according to claim 1, wherein the operating process of said slave device is as follows:
step 1 said RF transceiver module in said slave device switches to wake frequency, then it enters sleep mode; after it automatically wakes with internal timer, it waits for receiving said waking-up data packet; if it does not receive said waking-up data packet, after a waking-up period is end, it will enter sleep state again;
step 2 if it receives said waking-up data packet, it will judge whether to wake up said slave device or not; if it determines not to wake up said slave device, it will enter sleep state again after said waking-up period; if it determines to wake up said slave device, it will enter step 3;
step 3 said RF transceiver module switches to said operating frequency;
step 4 it broadcasts a news that said slave device has been wakened;
step 5 after said master device receives said news, it will send data frame to said slave device; said slave device receives said data frame from said master device and executes instruction;
step 6 after communication and service between said slave device and said master device are finished, said RF transceiver module switches to said wake frequency, and enters sleep state again.
